(19) United States
(12) Patent Application Publication
(10) Pub. No.: US 2005/0047417 A1
(43) Pub. Date: Mar. 3, 2005

(54) Apparatus and method for multimedia reproduction using output buffering in a mobile communication terminal

(75) Inventors: Seung-Cheol Lee, Yongin-si (KR); Hyo-Soon Lee, Seoul (KR); Sang-Beom Lee, Suwon-si (KR); Hyun-Sool Kim, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 10/822,309

(22) Filed: Apr. 12, 2004

(30) Foreign Application Priority Data
Aug. 26, 2003 (KR) 59037/2003

(51) Int. Cl. H04L 12/56

(52) U.S. Cl. 370/395.21; 370/235

(57) ABSTRACT

A multimedia reproduction apparatus in a mobile communication terminal comprising: a data parsing section for dividing multimedia data into video data and other data and then parsing the video data and the other data; a video data processing section for decoding the parsed video data; a media delay output controller for delaying the other data parsed by and transmitted from the data parsing section according to buffering information of the video data processing section, for outputting the delayed data, and for generating a synchronizing signal; an audio data processing section for decoding and outputting audio data from among the other data output from the media delay output controller; a video data output section for reading and outputting the video data; and a synchronizing section for synchronizing and outputting the video data.

### PRIORITY

This application claims priority to an application entitled “Apparatus and Method for Multimedia Reproduction Using Output Buffering in Mobile Communication Terminal” filed in the Korean Industrial Property Office on Aug. 26, 2003 and assigned Serial No. 2003-59037, the contents of which are hereby incorporated by reference.

### BACKGROUND OF THE INVENTION

1. Field of the Invention

The present invention relates to a multimedia reproduction apparatus in a mobile communication terminal.

2. Description of the Related Art

In progressing toward a highly information-oriented society, information and communication is increasing its importance as a society infrastructure, and communication service is moving the center of importance from the conventional wire communication to wireless communication, which attaches importance to mobility. Additionally, a new market, which is called wireless internet, combining internet and mobile communication is progressing at a rapid speed.

As described above, with the great increase of users' dependency on information and communication, and the improvement of wireless communication technologies, a first-generation analog system has changed into a second-generation digital system, and now a third-generation mobile communication (IMT-2000) centered on data communication is being developed.

Such a third-generation mobile communication system provides not only voice but also broadband multimedia service such as a video conference, Internet services, etc. In addition, the third generation system provides a data service up to 2 Mbps maximum in an office environment, thereby providing a true wireless multimedia service.

In order to achieve a multimedia service in a third-generation mobile communication system, transmission and reception are performed in a type of MPEG-4. MPEG-4 is a standard technology which reduces the size of a multimedia file to enable a two-way video service to be provided to a computer, a mobile communication terminal, a TV set-top box, etc, at a higher speed, and can be applied to all kinds of multimedia images such as a general broadcasting, Internet broadcasting, a movie, and a game including images for mobile communication terminals of 2.5 and 3rd generations.

In the above-mentioned third-generation mobile communication terminal, the reproduction function of multimedia data is a necessity. However, a multimedia service has characteristics that the quantity of data is large and many calculations are required. In addition, because a variety of specifications exist, such as 3rd Generation Partnership Project (3GPP), 3rd Generation Partnership Project 2 (3GPP2), Korea 3 Generation (K3G), Real-time Transport Protocol (RTP), different decoders according to the respective specifications are required. Particularly, video data is processed at low speed and has large differences in quantity of bits among frames. Therefore, in order to decode video data, a multimedia service requires at least two or three times longer processing capacity than that of a specified requirement (that is, an average processing time for frames) so that momentarily increased frames (for example, an intra-frame) can be processed.

FIG. 1 is a block diagram illustrating an example of a conventional mobile communication terminal. In the mobile communication terminal illustrated in FIG. 1, a controller 100 processes and controls a variety of functions including a short message service (SMS), as well as telephone calls and wireless internet connections. The mobile communication terminal includes a multimedia reproduction apparatus, which performs a multimedia reproduction operation in the present invention.

A memory 102 includes a Read Only Memory (ROM) in which micro codes of programs for process and control of the controller 100 and a variety of reference data is stored, a Random Access Memory (RAM) to be provided as a working memory for the controller 100, and a flash RAM to provide an area for storing a variety of updatable storage data including multimedia data. A voice processing section 104, which is connected with the controller 100, processes a telephone call, a voice recording, an incoming alarm output, etc., through a microphone and a speaker. A display section 106 displays received data and information required to be currently displayed.

More specifically, in the present invention, the voice processing section 104 and the display section 106 perform a video processing and a voice processing for reproducing multimedia data. A key input section 108 includes number keys of ‘0’to ‘9’ and a plurality of function keys including ‘menu’, ‘send’, ‘deletion’, ‘end’, ‘*’, ‘#’, and ‘volume’, and provides key input data corresponding to a key pressed by a user to the controller 100. A radio section 110 transmits and receives a radio signal to/from a Base Transceiver Station (BTS) through an antenna.

FIG. 2 illustrates an embodiment of a multimedia reproduction apparatus in a conventional mobile communication terminal. Herein, while a K3G-type multimedia reproduction apparatus is exampled, the description is identically applied to other multimedia reproduction apparatuses that decode multimedia data of other formats, such as 3GPP, 3GPP2, and so forth.

Referring to FIG. 2, a multimedia reproduction apparatus of a mobile communication terminal comprises: a K3G-type parser 202 for parsing the header file of multimedia data 201 into K3G format; a media controller 203 for dividing the parsed information into video data and audio data, transmitting the divided data with corresponding control information to decoders, and outputting a synchronizing signal to synchronize the video data and the audio data to each other; an MPEG4 (Moving Picture Experts Group 4) video decoder 204 and an H.263 decoder 205 for decoding the video data; an MPEG4 AAC (Advanced Audio Coding) decoder 206; an EVRC (Enhanced Variable Rate Coding) decoder 207; a MIDI decoder 208 for decoding the audio data; a video synchronizing section 210 for outputting decoded video information according to a synchronizing signal of the media controller 203 so that the decoded video information is output in synchronization with audio information; and an audio synchronizing section 211 for outputting decoded audio information according to a synchronizing signal of the media controller 203 so that the decoded audio information is output in synchronization with video information.

With the multimedia output of a mobile communication terminal using such a multimedia reproduction apparatus, because respective media data requires different decoding times from each other, a method for synchronizing the respective media data and a method for providing an optimized output critical time are becoming important issues. Particularly, determining an output critical time in consideration of decoding time difference between video data and audio data is an important subject from the viewpoint of efficient use of the resources in a mobile communication terminal which does not have many resources.

First, a relationship between processing times for each frame and an output critical time will be described with reference to FIGS. 3 and 4. In general, because the decoding time of an audio frame is much shorter than that of a video frame, it is sufficient to consider the decoding process of only a video frame. Therefore, the following description will be focused on the process of video frames.

FIG. 3 illustrates decoding timing for each class when an output critical time is set to 100 ms, and FIG. 4 illustrates the distribution of times required for video decoding process according to video frames. Referring to FIG. 3 illustrating decoding times for each frame, video data can be classified into intra-frames 302 needing the whole screen to be decoded and inter-frames 301, 303, and 304 needing a changed part of screen to be decoded. It should be noted that audio frames have much shorter decoding times than those of the video frames. Also, the output critical time of 100 ms that the occupancy times of the inter-frames and the audio frames are short, while the occupancy times of the intra-frames generated once every 10 frames on the average are long. Therefore, in a mobile communication terminal having limited resources, it is necessary to efficiently reduce the waiting times designated by ‘a’ in FIG. 3.

Referring to FIG. 4, in general, differences of processing times among frames are about 20 ms. However, at scene-changing parts designated by 41, 42, 43, and 44, the quantities of bits for corresponding frames are greatly increased in a moment, and thereby their decoding times also are greatly increased. Such a frame is called intra-frame, and shows that differences among frame processing times are about 60˜100 ms. Therefore, in order to process all frames, it is necessary to set the output critical time to about 100 ms, which is the maximum decoding time.

That is, while the average decoding time for each frame in FIG. 4 is no more than 46 ms, the output critical time must be set as 100 ms or more in order to process intra-frames having processing time differences of about 60˜100 ms. As illustrated in FIG. 4, the intra-frame is not continuous and has a characteristic that flat section is continuous for a considerable period after a momentary peak. In such a flat section, decoding time is 20 ms or so. With the relation between the peak and the flat section, it is considered that one peak (one intra-frame) occurs about every 10 frames. Therefore, when the output critical time is set for the intra-frame occurring once every 10 frames on the average, unnecessary consumption of resources is increased in process of the other frames. Accordingly, a solution capable of efficiently utilizing the resources is required.

FIG. 5 illustrates decoding timings for each class in a case in which the output critical time is set to 70 ms. According to FIG. 5, it is known that the waiting time ‘a’ is remarkably reduced as compared to FIG. 3 because the output critical time is set as 70 ms. However, with a section 302 in which an intra-frame is processed, because the output critical time is short, the intra-frame is decoded over the critical time as indicated by a reference number 51, so that there may be only an audio output without a video output. Also, the synchronization between video and audio can be failed as indicated by a reference number 52.

As described above, in the case of reducing the waiting time by a method of reducing the output critical time so as to efficiently utilize limited resources of a mobile communication terminal, quality of service (QOS), which is one of the most important factors in multimedia reproduction, is not satisfied. Therefore, research into a method for enabling the resources to be efficiently utilized is required in multimedia data reproduction of a mobile communication terminal.

### SUMMARY OF THE INVENTION

Accordingly, the present invention has been designed to solve the above and other problems occurring in the prior art, and an object of the present invention is to provide an apparatus and method for multimedia reproduction using output buffering in a mobile communication terminal, which can efficiently utilize limited resources in the mobile communication terminal through buffering of output data.

Another object of the present invention is to provide an apparatus and a method for multimedia reproduction supporting quality of service in data service of a mobile communication terminal.

In order to accomplish the above and other objects, there is provided a multimedia reproduction apparatus using output buffering in a mobile communication terminal. The apparatus comprises: a data parsing section for dividing multimedia data into video data and other data and then parsing the video data and the other data; a video data processing section for decoding the parsed video data, which are transmitted from the data parsing section, by the frame, and for buffering a predetermined number of video frames of the decoded data; a media delay output controller for delaying the other data parsed by and transmitted from the data parsing section according to buffering information of the video data processing section, for outputting the delayed data, and for generating a synchronizing signal; an audio data processing section for decoding and outputting audio data from among the other data output from the media delay output controller; a video data output section for reading and outputting the video data, which are buffered by the video data processing section, by the frame using control data from among the other data output from the media delay output controller; and a synchronizing section for synchronizing and outputting the video data output from the video data output section and the audio data output from the audio data processing section according to a synchronizing signal of the media delay output controller.

In accordance with another aspect of the present invention, there is provided a control method using output buffering so as to reproduce multimedia data in a mobile communication terminal. The control method comprises the steps of: (1) the mobile communication terminal receiving the multimedia data, dividing multimedia data into video data and other data, and parsing the video data and the other data respectively; (2) storing video frame start addresses of video data parsed in step (1), decoding the video data by the frame, and buffering a predetermined number of video frames; (3) outputting the other data parsed in step (1) after delaying the other data as long as the predetermined number of video frames buffered in step (2); (4) decoding and outputting audio data by the frame in which the audio data are included in data output in step (3), and outputting video frames buffered in step (2) according to control information included in data output in step (3); and (5) synchronizing and outputting video frames and audio frames output in step (4) according to time information.

### BRIEF DESCRIPTION OF THE DRAWINGS

The above and other objects, features, and advantages of the present invention will be more apparent from the following detailed description taken in conjunction with the accompanying drawings, in which:

FIG. 1 is a block diagram illustrating an example of a general mobile communication terminal;

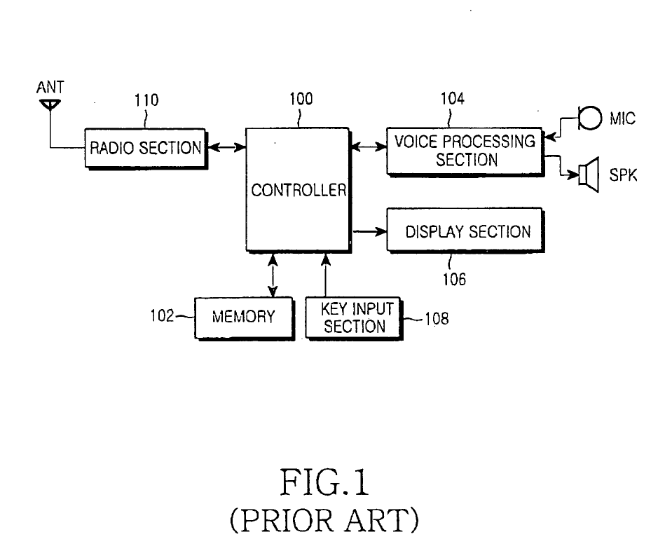

FIG. 2 illustrates an embodiment of a multimedia reproduction apparatus in a conventional mobile communication terminal;

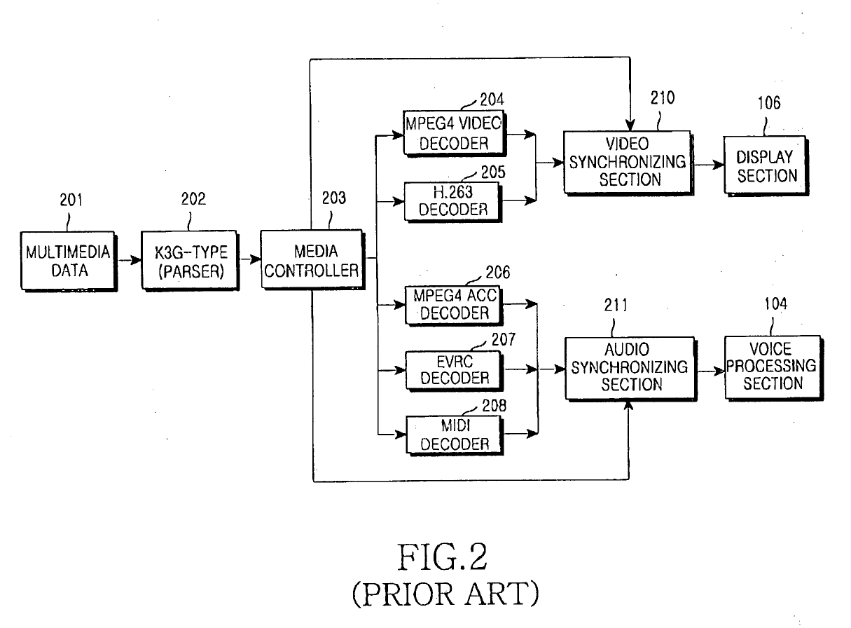

FIG. 3 illustrates decoding timing for each class in a case in which the output critical time is set to 100 ms;

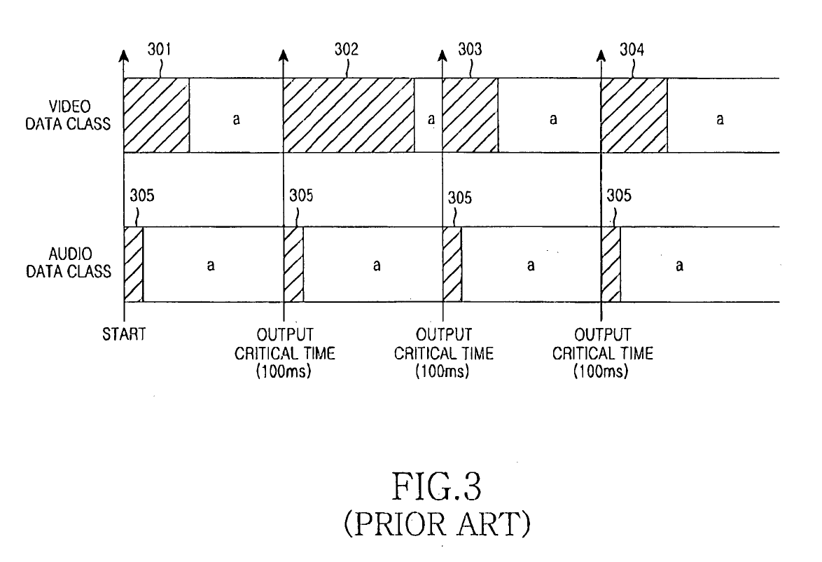

FIG. 4 illustrates the distribution of times required for video decoding process according to video frames;

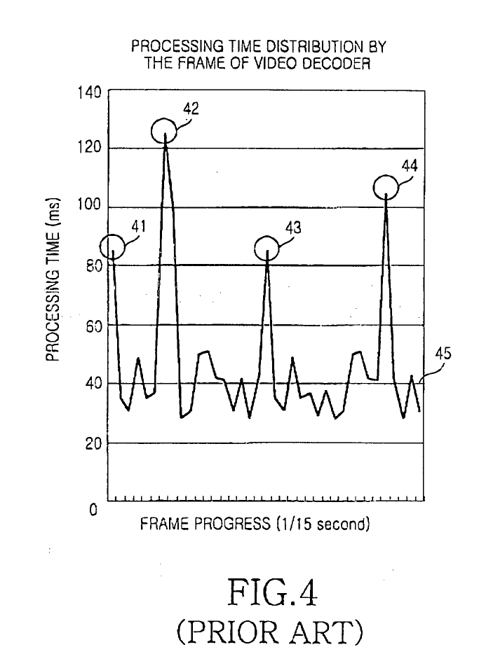

FIG. 5 illustrates decoding timing for each class in a case in which the output critical time is set to 70 ms;

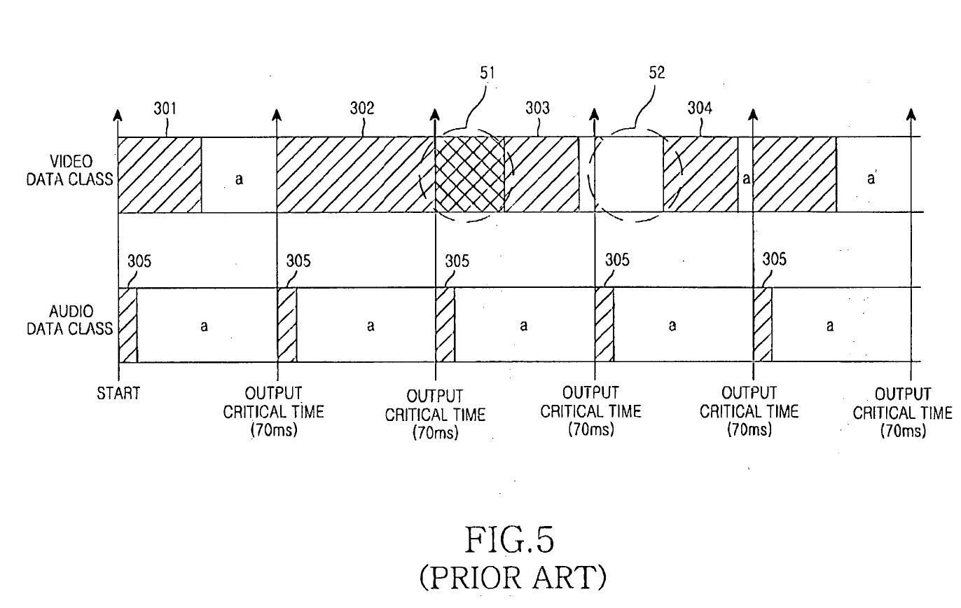

FIG. 6 illustrates a multimedia reproduction apparatus in a mobile communication terminal according to an embodiment of the present invention;

FIG. 7 illustrates distribution of times required for video decoding process according to buffering capacities for video frames; and

FIG. 8 illustrates reproduction of multimedia data in a mobile communication terminal according to an embodiment of the present invention.

### DETAILED DESCRIPTION OF THE PREFERRED EMBODIMENT

An apparatus and a method for multimedia reproduction using output buffering in a mobile communication terminal according to preferred embodiments of the present invention will be described in detail herein below with reference to the accompanying drawings. It is to be noted that the same elements are indicated with the same reference numerals throughout the drawings. Additionally, in the following description of the present invention, a detailed description of known functions and configurations incorporated herein will be omitted when it may make the subject matter of the present invention rather unclear.

The present invention, which has been designed to solve the problems occurring in the prior art, efficiently utilizes limited resources in a mobile communication terminal and uses output buffering for video output so as to guarantee the quality of service in a multimedia service.

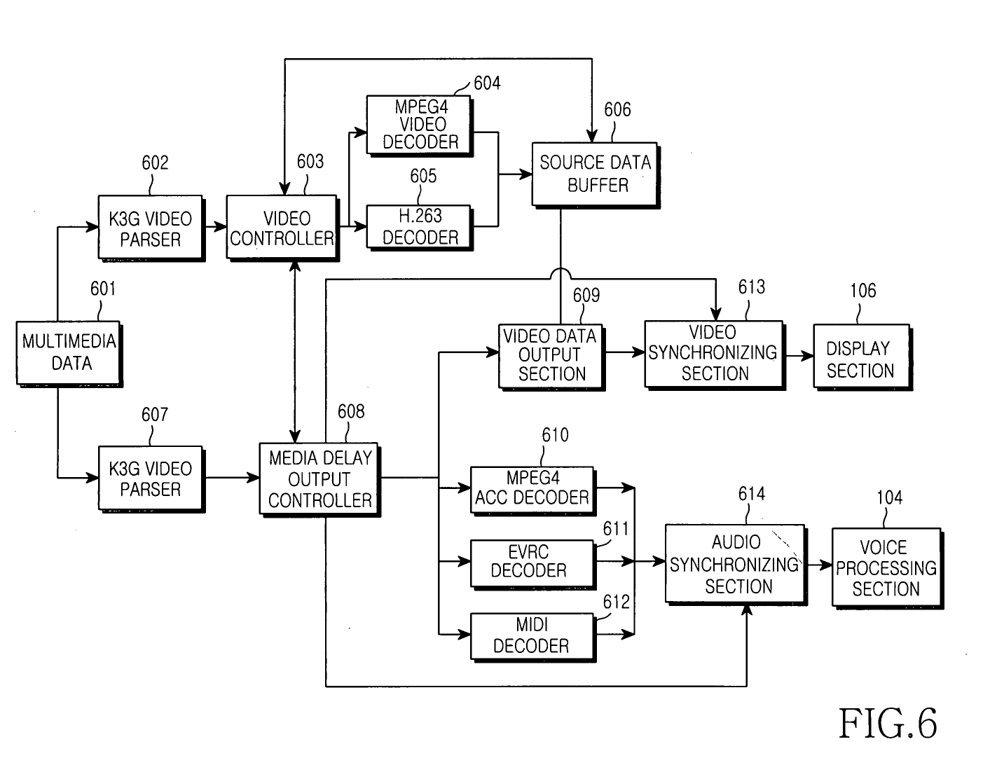

FIG. 6 illustrates a multimedia reproduction apparatus in a mobile communication terminal according to an embodiment of the present invention. Herein, while a K3G-type multimedia reproduction apparatus is exampled, the description is identically applied to other multimedia reproduction apparatuses, which decode multimedia data of other formats, such as 3GPP, 3GPP2, and so forth.

As illustrated in FIG. 6, a multimedia reproduction apparatus of a mobile communication terminal according to the present invention divides multimedia data 601 into a video part and the remaining multimedia part, and decodes the divided parts separately. That is, a multimedia reproduction apparatus of a mobile communication terminal according to the present invention comprises: a video module including a K3G-type video parser 602, a video controller 603, an MPEG4 video decoder 604, an H.263 decoder 605, a source data buffer 606, and a video data output section 609; the remaining multimedia module including a K3G-type parser 607, a media delay output controller 608, an MPEG4 Advanced Audio Coding (AAC) decoder 610, an Enhanced Variable Rate Coding (EVRC) decoder 611, and a MIDI decoder 612; and an output synchronizing module including a video synchronizing section 613 and an audio synchronizing section 614.

First, the multimedia data 601 is divided into different parts which are decoded in different ways according to the type of data by the K3G-type video parser 602 for parsing K3G video-type data and the K3G-type parser 607 for parsing the remaining multimedia information (mainly, audio data) with the exception of the video-type data.

The video controller 603 receives the parsed video data, and inputs the received data into the M-PEG4 video decoder 604 and the H.263 decoder 605 according to frames. At this time, the video controller 603 determines the input operation according to buffering information of the source data buffer 606. Also, multiple frames of audio data, not one frame of audio data, are decoded and output per one frame of video data, so the video controller 603 provides video frame input information to the media delay output controller 608 so that video is synchronized with audio. The MPEG4 video decoder 604 and the H.263 decoder 605 decode video data.

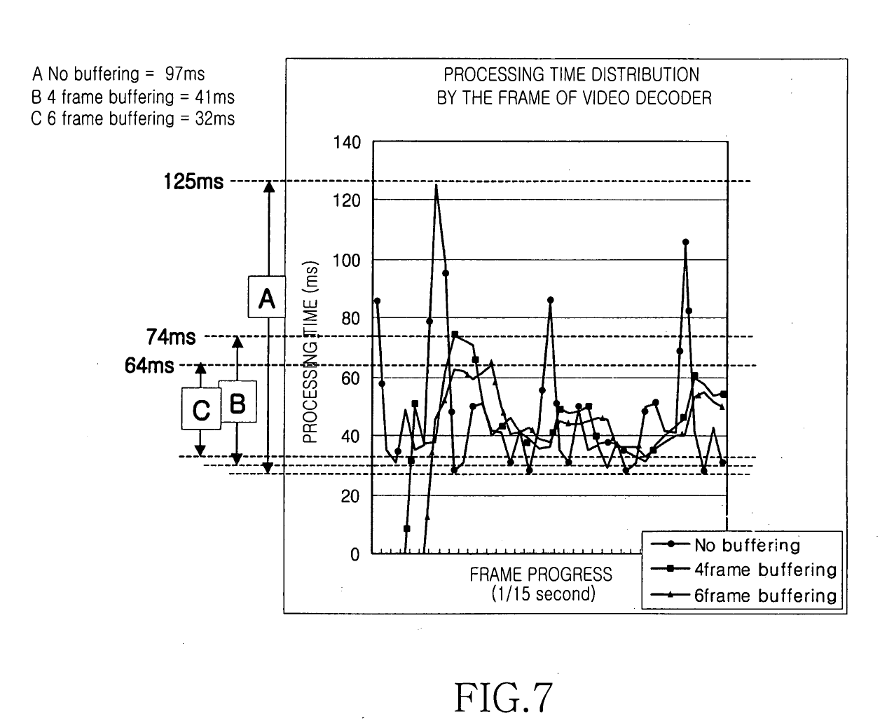

The source data buffer 606 buffers a pre-defined number of frames of the video data having been decoded by the MPEG4 video decoder 604 and the H.263 decoder 605, and outputs the video data by the frame according to a control signal of the video data control section 609. As described above, a multimedia reproduction apparatus according to the present invention performs a buffering operation for a pre-defined frame period before an output operation, unlike the conventional apparatus, which outputs data the moment the data is decoded. Therefore, it is possible to reduce the output critical time using the point that the average decoding time is constant even when decoding times for respective frames are different from each other. That is, an average decoding time for frames is output using a characteristic that the intra frame requiring a relatively long decoding time exists only once every ten frames and is not continued, so that it is possible to reduce the output critical time which have been set as a large value because of one intra-frame. This process is described with a distribution view of times required for video decoding process according to buffering capacities for video frames in which the distribution view is shown in FIG. 7.

FIG. 7 illustrates distribution of times required for video decoding process according to buffering capacities for video frames. Referring to FIG. 7, with no buffering ‘A’, because differences among decoding times for respective frames reaches up to 97 ms maximum, the output critical time must be set as 100 ms corresponding to the differences. However, with 4 frame buffering, the average decoding time is 41 ms and output time from the buffer also has the same value. Therefore, it is possible to reduce the output critical time to 50 ms. Also, with 6 frame buffering, the average decoding time is 38 ms and output time from the buffer has the same value. Therefore, it is possible to reduce the output critical time below 50 ms.

The K3G-type parser 607 parses control data and multimedia data excluding video data, and the media delay output controller 608 outputs a time-synchronizing signal to synchronize output of video data and audio data. The media delay output controller 608 inputs control data and multimedia data excluding video data by the frame according to a control signal of the video controller 603. In this case, the control data and multimedia data excluding video data have much more frames for one frame of video data, so one frame of video data does not require only one frame of different multimedia. That is, in a mobile communication terminal, video data is transmitted at a speed of 8 fps (frame per second), while audio data is transmitted at a speed of 25˜35 fps. Therefore, the media delay output controller 608 delays the time at which video data is buffered by a pre-defined number of frames, receives information indicating that the source data buffer 606 is full from the video controller 603, and outputs control data and multimedia data excluding video data from video source data corresponding to time information of video frames to be output from a buffer.

The MPEG4 ACC decoder 610, the EVRC decoder 611, and the MIDI decoder 612 decodes and outputs multimedia data (that is, audio data) excluding video data in which the multimedia data is provided from the media delay output controller 608. The video data output section 609 receives a control signal from the media delay output controller 608, reads video frames from the source data buffer 606, and outputs the read video frames. The video synchronizing section 613 and the audio synchronizing section 614 synchronizes and outputs video information output from the video data output section 609 and audio information output from the MPEG4 ACC decoder 610, the EVRC decoder 611, and the MIDI decoder 612, according to time synchronizing information input from the media delay output controller 608.

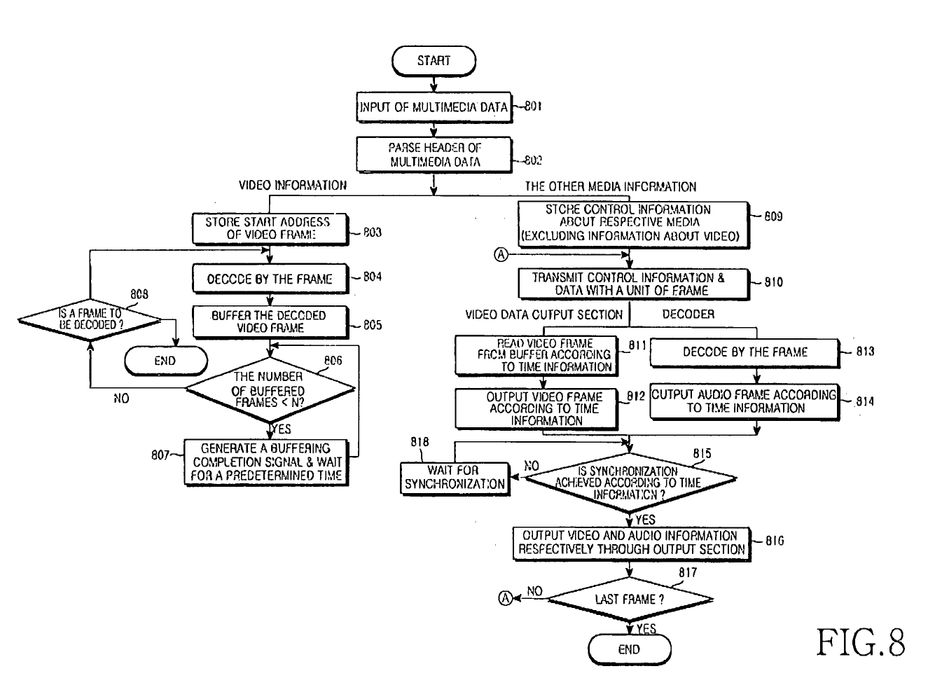

FIG. 8 is a flowchart illustrating reproduction of multimedia data in a mobile communication terminal according to an embodiment of the present invention. Referring to FIG. 8, first, multimedia data is input into a multimedia reproduction apparatus of a mobile communication terminal according to the present invention (step 801). In an embodiment of the present invention, while a case in which the input multimedia data is a K3G type is described, the present invention is identically applicable to other multimedia reproduction methods of decoding multimedia data of other formats, such as 3GPP, 3GPP2, and so forth.

Next, the header of the input multimedia data is parsed (step 802), so as to divide the data into video information and other multimedia information excluding the video information. Herein, with regard to video information, the start address of video frames is stored (step 803), and stored video frames are decoded according to frames (step 804).

Subsequently, the decoded video frames are buffered (step 805). Then, if the number of the buffered frames is not fewer than the number n of frames defined in advance for buffering (step 806), a buffering completion signal is generated and a waiting state is undergone for a predetermined time (that is, for a waiting time for outputting the buffered frames) (step 807), and step 806 is again performed after the predetermined time has passed. However, if the number of the buffered frames is fewer than the number N of frames pre-defined for buffering (step 806), whether or not there s another frame for buffering is determined in step 808. Then, if there is any other frame for buffering, step 804 is performed, and if there is no frame for buffering, the process is ended.

The pre-defined number N of frames for buffering is determined using the following factors during a process for parsing the headers of input video stream. First, the larger the size of encoded frames is, the larger the determined number N is, which can be judged as an actual size of data between the headers of frames. Number N can be increased according to the use of techniques, such as estimation of direct current (DC) and alternate current (AC), 4-motion vector (4MV) mode, unrestricted MV, and so forth, requiring a large number of calculations that greatly increases a compression ratio of an image. Also, number N can be increased when error resilient techniques, such as Resync marker, data partitioning, and so forth, in consideration of the use in wireless environment in which a lot of errors are generated in a video CODEC. From a number of experiments, it is determined that the factors may functions to increase number N by 0.5 per factor.

With the other media information excluding video information, control information about respective media is stored (step 809), control information and data by the frame are transmitted to the decoders 610 to 612 and the video data output section 609 (step 810).

Next, the decoders 610 to 612 decode audio data by the frame (step 813), and output audio frames according to time information (step 814). Also, the video data output section 609 reads video frames according to time information from a buffer (step 811), and outputs the read video frames according to the time information (step 812).

Subsequently, it is determined whether the outputs of the video frames and audio frames performed in steps 812 and 814 are synchronized with each other according to the time information (step 815). If synchronized, the video information and the audio information are output into each output section (for example, a display section 106 and a voice processing section 104) (step 816), and this process is repeated to the last frame (step 817).

However, when it is determined that the outputs of the video frames and audio frames performed in steps 812 and 814 are not synchronized with each other according to the time information (step 815), the video frames or the audio frames must wait for synchronization (step 818), and then the video frames or the audio frames are synchronized with each other and output (steps 816 and 817).

According to the present invention described above, when a multimedia data of a mobile communication terminal is reproduced, output data is buffered, so that limited resources of a mobile communication terminal can be efficiently used. Also, the present invention has an effect of supporting quality of service while multimedia data for a mobile communication terminal are provided using little resources.

The method described above according to the present invention can be realized as a program and stored a recoding medium (a CD ROM, a RAM, a floppy disk, a hard disk, a magneto-optical disk, and so forth) as a format capable of reading by a computer.

While the present invention has been shown and described with reference to certain preferred embodiments thereof, it will be understood by those skilled in the art that various changes in form and details may be made therein without departing from the spirit and scope of the invention as defined by the appended claims. Accordingly, the scope of the present invention is not to be limited by the above embodiments but by the claims and the equivalents thereof.

1. A multimedia reproduction apparatus using output buffering in a mobile communication terminal, the apparatus comprising:
a data parsing section for dividing multimedia data into video data and other data and then parsing the video data and the other data;
a video data processing section for decoding, by the frame, the parsed video data, which is transmitted from the data parsing section, and for buffering a predetermined number of video frames of the decoded data;
a media delay output controller for delaying the other data parsed by and transmitted from the data parsing section according to buffering information of the video data processing section, for outputting the delayed data, and for generating a synchronizing signal;
an audio data processing section for decoding and outputting audio data from among the other data output from the media delay output controller;
a video data output section for reading and outputting the video data buffered by the video data processing section, by the frame using control data from among the other data output from the media delay output controller; and
a synchronizing section for synchronizing and outputting the video data output from the video data output section and the audio data output from the audio data processing section according to a synchronizing signal of the media delay output controller.

2. The multimedia reproduction apparatus as claimed in claim 1, wherein the video data processing section comprises:
a video controller for outputting the parsed video data received from the data parsing section by the frame;
a video decoder decoding the video data received by the frame through the video controller, by the frame; and
a buffer for buffering the predetermined number of video frames of the decoded video data, and transmitting a buffering completion signal to the video controller when the predetermined number of video frames have been buffered, the video controller transmitting buffering information to the media delay output controller according to the buffering completion signal received from the buffer.

3. The multimedia reproduction apparatus as claimed in claim 1, wherein the synchronizing signal of the media delay output controller is time information.

4. The multimedia reproduction apparatus as claimed in claim 1, wherein the predetermined number of video frames are buffered, so that the video data is output by an average decoding time of the predetermined and buffered number of video frames.

5. The multimedia reproduction apparatus as claimed claim 1, wherein the multimedia data is data of a Korea 3 Generation (K3G) type.

6. The multimedia reproduction apparatus as claimed in claim 1, wherein the multimedia data is data of a third Generation Partnership Project (3GPP) type.

7. The multimedia reproduction apparatus as claimed in claim 1, wherein the multimedia data is data of a third Generation Partnership Project 2 (3GPP2) type.

8. The multimedia reproduction apparatus as claimed in claim 1, wherein the multimedia data is data of a Real-time Transport Protocol (RTP) type.

9. A control method using output buffering to reproduce multimedia data in a mobile communication terminal, the control method comprising the steps of:
(1) receiving the multimedia data, dividing multimedia data into video data and other data, and parsing the video data and the other data, respectively, in the mobile communication terminal;
(2) storing video frame start addresses of the video data parsed in step (1), decoding the video data by the frame, and buffering a predetermined number of video frames;
(3) outputting the other data parsed in step (1) after delaying the other data as long as the predetermined number of video frames buffered in step (2);
(4) decoding and outputting audio data by the frame in which the audio data is included in the data output in step (3), and the outputting video frames buffered in step (2) according to control information included in the data output in step (3); and
(5) synchronizing and outputting the video frames and audio frames output in step (4) according to time information.

10. The control method as clamed in claim 9, further comprising a step (6) of generating a buffering completion control signal when the predetermined number of video frames have been buffered in step (2), transmitting the buffering completion control signal, and controlling the delaying process of step (3) to be performed.

11. The control method as clamed in claim 9, wherein the predetermined number of video frames are buffered and output, so that the video frames are output by an average decoding time of the predetermined and buffered number of video frames.

12. The control method as clamed in claim 9, wherein, in step (5), when the time information of a video frame and an audio frame output in step (4) does not correspond to each other, a frame having prior time information waits for the other frame from among the video frame and the audio frame, thereby performing the synchronization.
